(19) United States
(12) Patent Application Publication
(10) Pub. No.: US 2026/0043600 A1
(43) Pub. Date: Feb. 12, 2026

(54) REFRIGERATOR

(71) Applicant: LG Electronics Inc., Seoul (KR)

(72) Inventor: Kwanghyun CHOI, Seoul (KR)

(21) Appl. No.: 19/283,724

(22) Filed: Jul. 29, 2025

(30) Foreign Application Priority Data
Aug. 9, 2024 (KR) 10-2024-0106837

(51) Int. Cl. F25D 23/02; E05D 3/18; E05D 11/00

(52) U.S. Cl. CPC F25D 23/028; E05D 3/18; E05D 11/0054; E05Y 2900/31; F25D 2323/024

(57) ABSTRACT

A refrigerator includes a cabinet; a door including a hinge mounting part on an upper surface of the door; a hinge device including a hinge plate mounted on the cabinet, and a hinge pin protruding from the hinge plate toward the door and connected to the hinge mounting part; a hinge cover arranged across an upper surface of the cabinet and the hinge mounting part and covering the hinge device; and a guide member provided on the hinge mounting part and having a guide groove configured to allow the hinge pin to be inserted and guiding the movement of the hinge pin when the door rotates, and the hinge mounting part has a guide hole which is arranged in front of the guide member and in which a water supply pipe extending from the cabinet to the inside of the door is guided.

### BACKGROUND

The present disclosure relates to a refrigerator.

In general, a refrigerator is a home appliance that can store food at low temperatures in an internal storage space that is shielded by a door. To this end, the refrigerator is configured to cool the inside of the storage space by using cold air generated through heat exchange with a refrigerant that circulates a refrigeration cycle, thereby allowing the stored food to be stored in an optimal condition.

Recently, refrigerators are becoming larger and more multifunctional in line with the changing eating habits and the trend toward higher quality products, and refrigerators with various structures that take user convenience into consideration are being released.

In particular, recently, refrigerators are designed to be built into walls or arranged to be in harmony with other furniture or home appliances. At this time, refrigerators require a certain distance to prevent the corners of the door that rotates from interfering with neighboring walls, furniture, or home appliances. However, such a distance not only creates unnecessary space for the refrigerator to be arranged, but also causes problems with poor appearance.

To solve these problems, refrigerators equipped with hinges of a multi-link structure are being developed. However, refrigerators of a multi-link structure have the problem of being complex in structure and expensive. In addition, due to the characteristics of the multi-link operation structure, there are safety vulnerabilities such as the user's body being caught between the links, and there is the problem of poor door rotational manipulability.

### SUMMARY

An object of an embodiment of the present disclosure is to provide a refrigerator capable of minimizing the distance from the wall by preventing interference with the wall on which the refrigerator is installed when the door rotates.

An object of an embodiment of the present disclosure is to provide a refrigerator in which two hinge pins are configured to move along guide grooves formed on the upper surface of a door, thereby improving the operational feel when the door is opened and closed.

An object of an embodiment of the present disclosure is to provide a refrigerator capable of preventing a water supply pipe from being exposed to the outside even during the rotation of the door by means of a hinge cover that covers a hinge device from the upper part and covers a guide hole through which a water supply pipe for supplying water to the door passes.

An object of an embodiment of the present disclosure is to provide a refrigerator in which the thickness of the door can be slimmed down by means of a structure that minimizes the distance between a hinge cover that covers a hinge device and a guide hole together and the front surface of the door.

An object of an embodiment of the present disclosure is to provide a refrigerator capable of easily manufacturing a structure which is configured so that the hinge cover covers the guide hole, in a door in which a guide hole through which a water supply pipe passes is formed on an upper surface.

According to an embodiment of the present disclosure to solve the above problem, a refrigerator includes a cabinet forming a storage space; a door configured to open and close the storage space and including a hinge mounting part formed on an upper surface of the door; a hinge device including a hinge plate mounted on the cabinet, and a hinge pin protruding from the hinge plate toward the door and connected to the hinge mounting part; a hinge cover arranged across an upper surface of the cabinet and the hinge mounting part and covering the hinge device; and a guide member provided on the hinge mounting part and having a guide groove configured to allow the hinge pin to be inserted and guiding the movement of the hinge pin when the door rotates, and the hinge mounting part has a guide hole which is arranged in front of the guide member and in which a water supply pipe extending from the cabinet to the inside of the door is guided.

The hinge cover may maintain a state of covering the guide hole during a rotation process of the door.

The hinge pin may include a first pin and a second pin that are spaced apart from each other, and the guide groove may be configured so that both the first pin and the second pin are inserted and guides the movement of the first pin and the second pin when the door rotates.

The door further includes an upper cap decoration that forms the upper surface of the door and includes the hinge mounting part, and a front end of the hinge cover may be disposed between the guide hole and a front surface of the upper cap decoration.

The front end of the hinge cover may be maintained in a state of being disposed between the guide hole and the front surface of the upper cap decoration during the rotation process of the door.

The door further includes a front panel forming a front surface of the door, and the front panel may cover the front surface of the upper cap decoration.

The door may include an upper cap decoration forming an upper surface of the door and including the hinge mounting part, and a cap decoration cover mounted on a front surface of the upper cap decoration, the upper cap decoration may include a cap decoration frame forming an opened frame opening and arranged in front of the hinge mounting part, and the cap decoration cover may cover the frame opening.

A front end of the hinge cover may be located inside the frame opening.

A front end of the hinge cover may be disposed between the guide hole and the cap decoration cover.

The upper cap decoration may include a cover mounting hole disposed on the front surface thereof, and the cap decoration cover may include a cover mounting part mounted on the cover mounting hole.

The door further includes a front panel forming a front surface of the door, and the front panel may cover a front surface of the cap decoration cover.

The hinge cover may include a cover body part disposed on an upper surface of the cabinet, and a cover protrusion part extended forward from the cover body part and disposed on the hinge mounting part, and the cover protrusion part may maintain a state of covering the guide hole during the rotation process of the door.

The door further may include a front panel forming a front surface of the door, and the front end of the cover protrusion part may be maintained in a state of being arranged between the guide hole and the front panel during the rotation of the door.

The guide member may have a shape in which both end parts are bent toward a front, and the guide member may be arranged to surround the guide hole.

The refrigerator further includes a dispenser provided inside the door, configured to dispense water, and connected to the water supply pipe, the water supply pipe may be guided through the hinge cover and the guide hole and extends to the dispenser.

A refrigerator according to one embodiment has the following effects:

According to one embodiment of the disclosure, a refrigerator can prevent interference with a wall on which the refrigerator is installed when the door rotates, thereby minimizing the distance from the wall.

According to a refrigerator according to one embodiment, two hinge pins are configured to move along guide grooves formed on the upper surface of the door, so that the operational feel when the door is opened and closed can be improved.

According to a refrigerator according to one embodiment, by means of a hinge cover that covers a hinge device from the upper part and a guide hole through which a water supply pipe for supplying water to the door passes, the water supply pipe can be prevented from being exposed to the outside even during the rotation of the door.

According to a refrigerator according to one embodiment, the thickness of the door can be configured slimly, by means of a structure that minimizes the distance between the hinge cover covering the hinge device and the guide hole and the front surface of the door.

According to a refrigerator according to one embodiment, by means of a structure including an upper cap decoration and a cap decoration cover coupled to the front of the upper cap decoration, a structure which is configured so that the hinge cover covers the guide hole can be easily manufactured, in a door in which a guide hole through which a water supply pipe passes is formed on an upper surface.

### BRIEF DESCRIPTION OF THE DRAWINGS

FIG. 1 is a front view illustrating a refrigerator installed according to one embodiment.

FIG. 2 is a rear perspective view illustrating a refrigerator according to one embodiment.

FIG. 3 is a schematic diagram illustrating the internal structure of a refrigerator door according to one embodiment.

FIG. 4 is a perspective view illustrating an upper cap decoration according to one embodiment.

FIG. 5 is a cross-sectional perspective view taken along line 5-5 of FIG. 4.

FIG. 6 is an exploded perspective view illustrating a hinge cover, hinge, and upper cap decoration of a refrigerator according to one embodiment.

FIG. 7 is an exploded perspective view illustrating the hinge device and guide member.

FIG. 8 is a cross-sectional perspective view taken along line 8-8 of FIG. 2.

FIG. 9 is a schematic diagram illustrating the positional relationship between the hinge cover and the upper cap decoration.

FIG. 10 is a perspective view illustrating the front panel forming the front surface of the door.

FIG. 11 is a bottom perspective view illustrating a hinge mounting part of an upper cap decoration according to one embodiment.

FIG. 12 is an exploded perspective view illustrating the upper cap decoration and cap decoration cover according to one embodiment.

FIGS. 13 to 16 are schematic diagrams illustrating the door opening process.

FIG. 17 is a perspective view illustrating an upper cap decoration according to another embodiment.

FIG. 18 is a front view illustrating a refrigerator according to another embodiment.

FIG. 19 is a front view illustrating a state where a door of a refrigerator is open according to another embodiment.

FIG. 20 is an enlarged perspective view illustrating a door hinge part of a refrigerator according to another embodiment.

FIG. 21 is an enlarged perspective view illustrating a door hinge part in a state where the sub-door is open in a refrigerator according to another embodiment.

FIG. 22 is an exploded perspective view illustrating the upper cap decoration and the sub door in a refrigerator according to another embodiment.

### DETAILED DESCRIPTION

Hereinafter, specific embodiments of the present disclosure will be described in detail with reference to the drawings. However, the present disclosure is not limited to the embodiments in which the idea of the present disclosure is presented, and other regressive disclosures or other embodiments included within the scope of the idea of the present disclosure can be easily proposed by adding, changing, deleting, or the like other components.

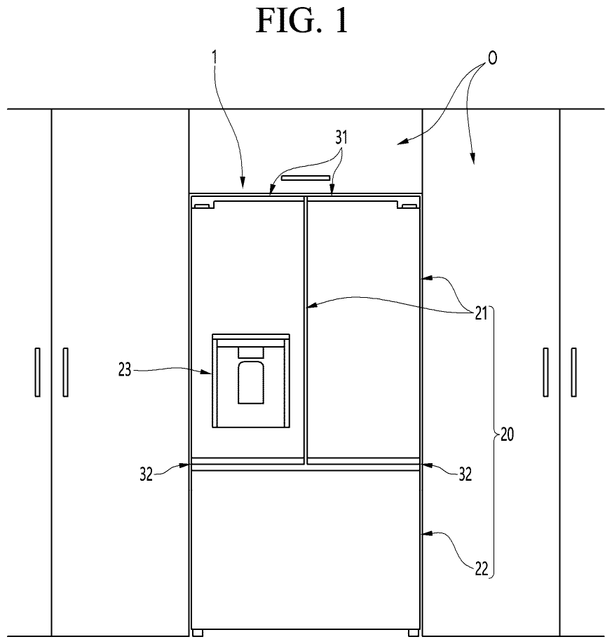

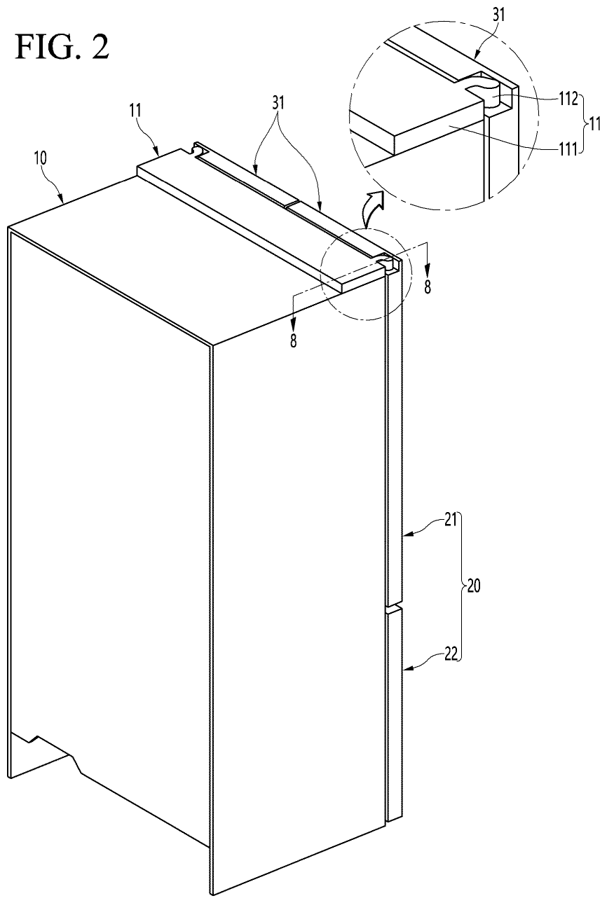

Before explanation, the direction is defined. In an embodiment of the present disclosure, the direction in which the front surface of the door as illustrated in FIGS. 1 and 2 faces may be defined as a front direction, the direction toward the cabinet based on the front surface of the door may be defined as a rear direction, the direction toward the floor surface on which the refrigerator is installed may be defined as a lower direction, and the direction away from the floor surface may be defined as an upper direction. In addition, when you want to talk about an undefined direction, you can explain it by defining the direction based on each drawing.

Although the embodiment of the present disclosure describes a refrigerator in which a refrigerating compartment and a freezing compartment are arranged vertically and each has a door, it should be noted in advance that the present disclosure is not limited to the structure and shape of the refrigerator and can be applied to all types of refrigerators having a rotating door.

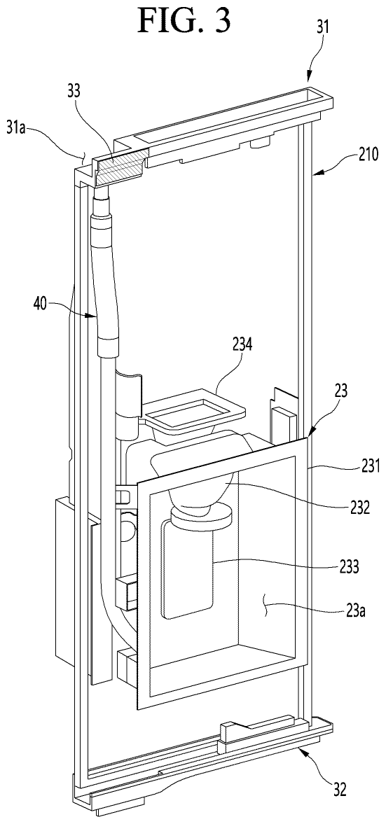

FIG. 1 is a front view illustrating a refrigerator installed according to one embodiment, FIG. 2 is a rear perspective view illustrating a refrigerator according to one embodiment, and FIG. 3 is a schematic diagram illustrating the internal structure of a refrigerator door according to one embodiment.

Referring to FIGS. 1 to 3, a refrigerator 1 according to one embodiment may have its overall outer appearance formed by a cabinet 10 forming a storage space and a door 20 for opening and closing the storage space.

The refrigerator 1 can be installed so as to be in harmony with the furniture or wall 0 of the indoor space. For example, as illustrated in FIG. 1, the refrigerator 1 can be installed in an indoor space such as a kitchen, and can be arranged so as to be in harmony adjacent to the furniture or wall 0. In other words, a space corresponding to the size of the refrigerator 1 is provided in the furniture or wall 0, and the refrigerator 1 can be accommodated in the space, or can be arranged as a built-in type. Of course, in addition to the furniture or wall 0, the refrigerator 1 can be arranged in a series with a plurality of refrigerators or other home appliances.

In the arrangement structure of the refrigerator 1 as described above, the front surface of the door 20 forming the front surface of the refrigerator I can be arranged very close to the furniture or wall 0. Accordingly, the front surface of the door 20 and the furniture or wall 0 can be arranged on the same or adjacent planes to have a sense of unity.

The cabinet 10 can form a storage space. For example, the storage space of the cabinet 10 can be partitioned vertically and include an upper storage space and a lower storage space.

The door 20 may be configured to open and close the storage space of the cabinet 10. The door 20 may include an upper door 21 that opens and closes the upper storage space and a lower door 22 that opens and closes the lower storage space. For example, the upper storage space may be a refrigerating compartment, and the lower storage space may be a freezing compartment. Accordingly, the upper door 21 may be referred to as a refrigerating compartment door, and the lower door 22 may be referred to as a freezing compartment door.

The upper door 21 can be rotatably connected to the cabinet 10 by a hinge device 50. For example, a pair of upper doors 21 can be rotatably connected to the cabinet 10 by hinge devices 50 provided at the upper end and lower end.

For example, a hinge device 50 provided on the upper end of the upper door 21 will be described, and the hinge device 50 is mounted on the upper surface of the cabinet 10 and can be rotatably coupled to the upper door 21.

A hinge cover 11 that covers the hinge device 50 from the upper side may be placed on the upper part of the cabinet 10. The hinge cover 11 is mounted on the upper part of the cabinet 10 and may have a shape that partially protrudes toward the upper door 21 to cover the hinge device 50. The hinge cover 11 may have a shape that is opened on the lower side. Accordingly, components placed on the lower part of the hinge cover 11 may not be interfered with by the hinge cover 11. The hinge device 50 may be covered by the hinge cover 11 and may not be exposed to the outside.

For example, the hinge cover 11 may include a cover body part 111 disposed on the cabinet 10 and a cover protrusion part 112 protruding forward from the cover body part 111. The cover body part 111 covers the upper surface of the cabinet 10, and the cover protrusion part 112 may cover the upper surface of the upper door 21. In the hinge device 50, a part mounted on the cabinet 10 may be covered by the cover body part 111, and a part protruding toward the upper door 21 may be covered by the cover protrusion part 112.

The upper door 21 may include a door frame 210 forming an outer shape, an upper cap decoration 31 forming an upper surface, and a lower cap decoration 32 forming a lower surface. For example, the upper cap decoration 31 and the lower cap decoration 32 may be injection molded from a plastic material.

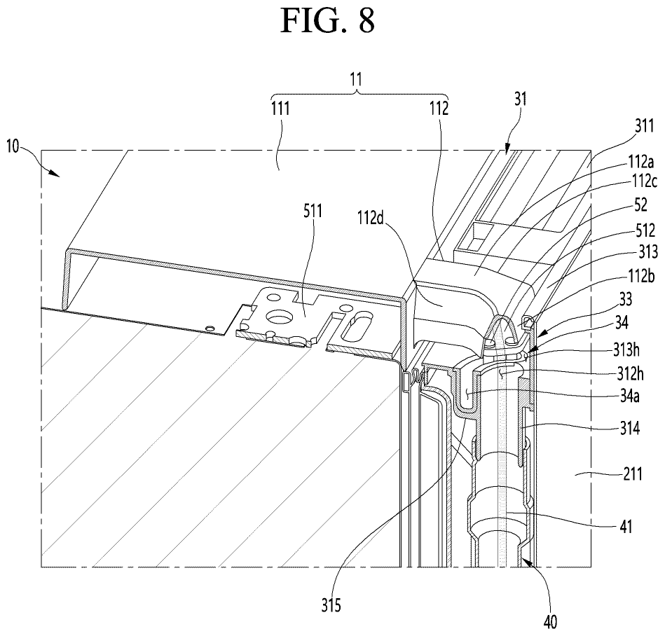

The door frame 210 can form the outer shape of the upper door 21. For example, the door frame 210 can have a frame shape that is opened in a rectangular shape. Although not illustrated, other components that constitute the upper door 21 can be combined with the door frame 210. For example, a front panel (‘211’ in FIG. 8) that constitutes the front surface of the upper door 21 and a door liner that constitutes the rear surface can be combined with the door frame 210.

An upper cap decoration 31 may be placed on the upper part of the door frame 210. For example, the upper cap decoration 31 may be coupled to the upper end of the door frame 210. A hinge device 50 for rotating the upper door 21 may be rotatably mounted on the upper cap decoration 31.

The upper cap decoration 31 may include a hinge mounting space 31a in which a hinge device 50 is mounted. The hinge mounting space 31a may be formed by partially recessing the upper surface of the upper cap decoration 31 downward. In other words, the hinge mounting space 31a may be formed by partially recessing the rear surface of the upper cap decoration 31 forward.

The upper door 21 may further include a cap decoration cover 33 mounted on the front surface of the upper cap decoration 31. The cap decoration cover 33 may be positioned in front of the hinge mounting space 31a.

A detailed description of the upper cap decoration 31 and cap decoration cover 33 will be provided later.

A dispenser 23 for discharging water may be formed in the upper door 21. The dispenser 23 may be formed in either of the pair of upper doors 21. The dispenser 23 may be provided on the front surface of the upper door 21.

The dispenser 23 may include a dispenser case 231 including a recessed space 23a, an extraction part 232 arranged in the recessed space 23a and configured to extract water, and an extraction lever 233 connected to the extraction part 232 to extract water through manipulation. In other words, a user may cause water to be extracted from the extraction part 232 through manipulation of the extraction lever 233.

Although not illustrated, an ice-making module for generating ice may be provided on the upper part of the dispenser 23. The dispenser 23 may further include an ice chute 234 that receives ice generated from the ice-making module. For example, ice provided to the dispenser 23 through the ice chute 234 may be discharged through the extraction part 232.

The upper door 21 according to one embodiment may further include a guide part 40 coupled to the upper cap decoration 31. The guide part 40 may provide a path for a water supply pipe 41 or an electric wire extending into the interior of the upper door 21. The water supply pipe 41 or an electric wire extending into the interior of the upper door 21 may be protected by the guide part 40 during the foaming process of the insulating material disposed inside the upper door 21.

As will be described later, the water supply pipe 41 guided by the guide part 40 can be connected to the extraction part 232 of the dispenser 23. Accordingly, water supplied through the water supply pipe 41 can be provided to the dispenser 23. In addition, the water supply pipe 41 can be connected to the ice-making module to supply water necessary for ice-making.

The lower door 22 may be connected to the cabinet 10 so as to be drawable. In other words, the lower door 22 may be a door that opens and closes in a drawer manner with respect to the cabinet 10. However, the lower door 22 is not limited thereto, and may be rotatably connected to the cabinet 10 by a hinge device 50 like the upper door 21.

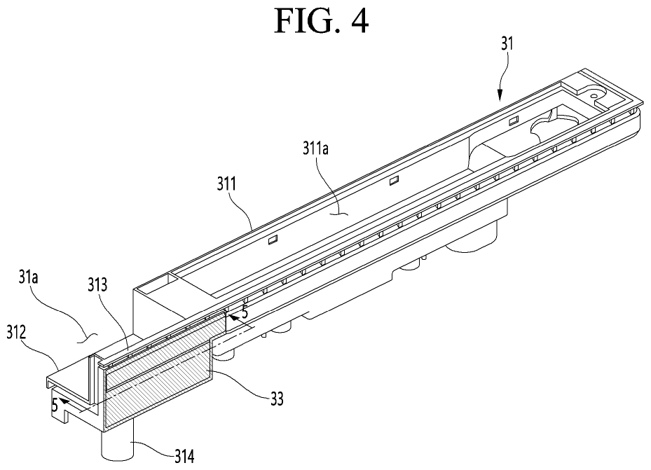

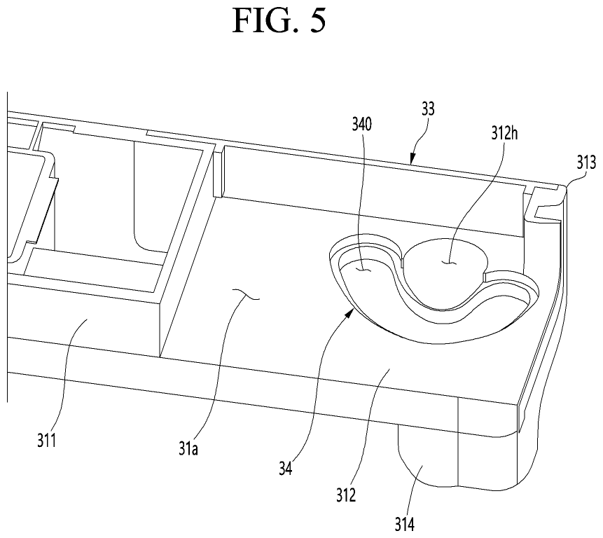

Below, the structure of the upper cap decoration 31 will be described with reference to FIGS. 4 and 5.

FIG. 4 is a perspective view illustrating an upper cap decoration according to one embodiment, and FIG. 5 is a cross-sectional perspective view taken along line 5-5 of FIG. 4.

Referring to FIGS. 4 and 5, an upper cap decoration 31 according to one embodiment may include a decoration body 311 and a hinge mounting part 312 disposed on one side of the decoration body 311.

The decoration body 311 may include a receiving part 311a that is recessed downward. The receiving part 311a may have an upwardly open shape. A PCB for controlling various modules provided in the upper door 21 may be received in the receiving part 311a. For example, a dispenser PCB for controlling the operation of a dispenser 23 may be received in the receiving part 311a. Although not illustrated, the receiving part 311a of the upper cap decoration 31 may be shielded by a decoration upper cover.

The hinge mounting part 312 may be located on one side of the decoration body 311. The hinge mounting part 312 may have a rotation axis arranged around which the upper door 21 rotates. The hinge mounting part 312 may include a recessed hinge mounting space 31a. For example, the hinge mounting part 312 may have an upper surface recessed downward to form the hinge mounting space 31a. In other words, the hinge mounting part 312 may have a rear surface recessed forward to form the hinge mounting space 31a.

A hinge guide member 34 may be mounted on the hinge mounting part 312. For example, the hinge guide member 34 may be mounted by being inserted into the lower surface of the hinge mounting part 312. A hinge device 50 may be rotatably connected to the hinge guide member 34 to guide the rotation of the upper door 21.

A guide hole 312h may be formed in the hinge mounting part 312. The guide hole 312h may be connected to the interior of the upper door 21. A configuration extending toward the interior of the upper door 21 may be arranged to penetrate through the guide hole 312h. For example, a water supply pipe 41 or an electric wire extending toward the interior of the upper door 21 may be arranged to penetrate through the guide hole 312h. The guide hole 312h may communicate with a guide connection part 314 described below. Accordingly, the water supply pipe 41 extending toward the interior of the upper door 21 may be extended toward the guide connection part 314 through the guide hole 312h and guided to the guide part 40. The guide hole 312h may be covered from the upper side by a hinge cover 11.

The upper cap decoration 31 may further include a cap decoration frame 313 positioned in front of the hinge mounting part 312 and a guide connecting part 314 positioned at the lower end of the hinge mounting part 312.

A cap decoration frame 313 may be placed in front of the hinge mounting part 312. The cap decoration frame 313 may form a part of the front surface of the upper cap decoration 31. The cap decoration frame 313 may include a frame opening 313h that is open in the front and rear direction. A cap decoration cover 33 that shields the frame opening 313h may be mounted on the cap decoration frame 313.

In other embodiments, the cap decoration frame 313 may be omitted in some cases. For example, if the cap decoration cover 33 is omitted, the cap decoration frame 313 may be omitted. In this case, the hinge mounting space 31a may be shielded by a configuration coupled to the front surface of the upper cap decoration 31.

A guide connection part 314 may be arranged at the lower part of the hinge mounting part 312. As described above, the guide connection part 314 may communicate with the guide hole 312h formed in the hinge mounting part 312. The guide connection part 314 may have a shape that protrudes downward from the lower surface of the hinge mounting part 312. The guide connection part 314 may be connected to the guide part 40. Accordingly, the water supply pipe 41 extending toward the guide connection part 314 through the guide hole 312h may be guided to the guide part 40.

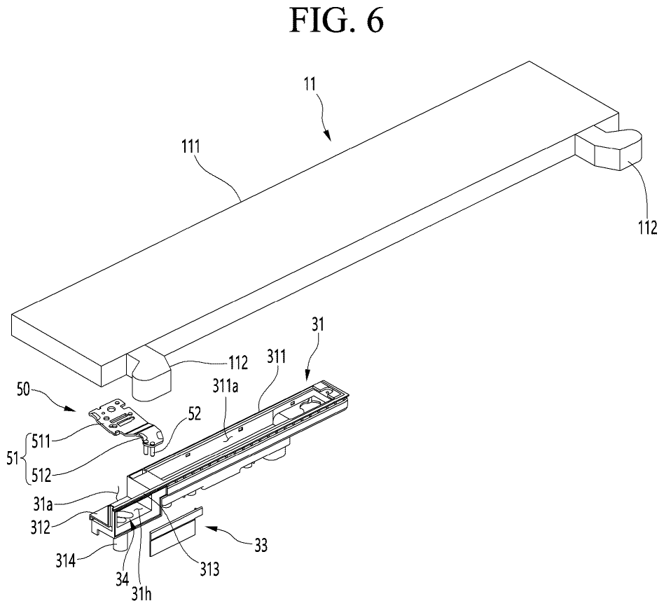

Hereinafter, the mounting structure of the hinge device 50 will be described with reference to FIGS. 6 to 8.

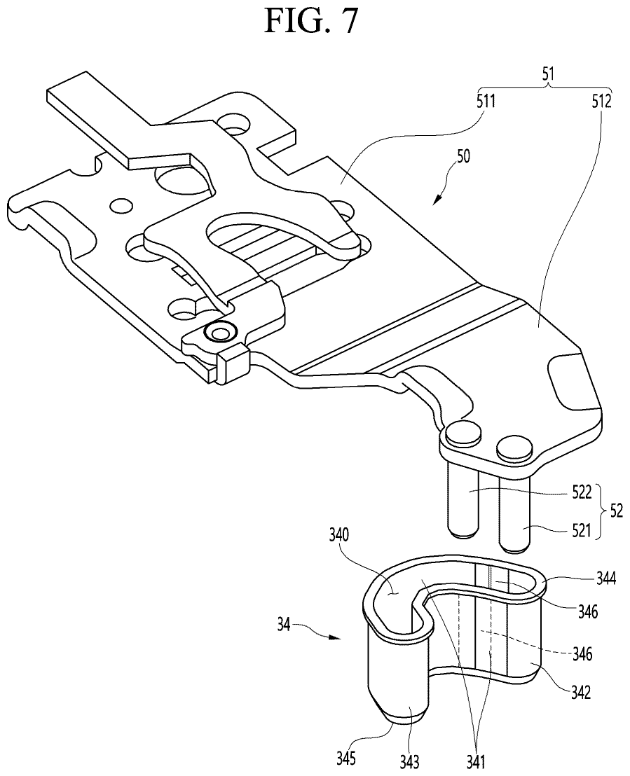

FIG. 6 is an exploded perspective view illustrating a hinge cover, hinge, and upper cap decoration of a refrigerator according to one embodiment, FIG. 7 is an exploded perspective view illustrating the hinge device and guide member, and FIG. 8 is a cross-sectional perspective view taken along line 8-8 of FIG. 2.

Referring to FIGS. 6 to 8, a hinge device 50 can connect the upper part of the cabinet 10 and the upper door 21. The hinge device 50 can include a hinge plate 51 and a hinge pin 52.

The hinge plate 51 may be formed of a plate-shaped metal material and may protrude forward from the upper surface of the cabinet 10. The hinge plate 51 may extend to the hinge mounting part 312 of the upper door 21. For example, the hinge plate 51 may include a hinge fixing part 511 fixed to the cabinet 10 and a hinge extension part 512 extending forward from the hinge fixing part 511 and having a hinge pin 52 mounted thereon.

The hinge extension part 512 can extend to the guide groove 340 inside the hinge mounting part 312. A hinge pin 52 can be mounted on the hinge extension part 512.

The hinge pin 52 may extend downward from the hinge extension part 512. For example, the hinge pin 52 may be press-fitted and coupled to penetrate the hinge extension part 512.

The hinge pin 52 may be configured as a pair. The pair of hinge pins 52 may be formed in the same shape and may be formed in a size that can be inserted into the guide groove 340 formed in the hinge mounting part 312. For example, each hinge pin 52 may have a circular cross-section and may have a diameter corresponding to the inner width of the guide groove 340. Accordingly, the pair of hinge pins 52 may be moved to a state where they are inserted into the guide groove 340 and come into contact with the inner surface of the guide groove 340.

A pair of hinge pins 52 may be spaced apart from each other. Each of the pair of hinge pins 52 may be spaced apart from the front and side surfaces of the upper door 21 by different distances. For example, the hinge pins 52 may include a first pin 521 and a second pin 522. The first pin 521 may be positioned closer to the front surface of the upper door 21 than the second pin 522. The first pin 521 may be positioned farther from one side surface of the upper door 21 than the second pin 522. The first pin 521 and the second pin 522 may be spaced apart from each other by a set distance.

A pair of hinge pins 52 can be spaced apart from each other in the front and rear direction and in the left and right direction when viewed from the front. An extension line passing through the centers of the first pin 521 and the second pin 522 can be extended in an inclined direction based on the front surface of the upper door 21.

The upper door 21 can be opened by moving in the direction of the extension line of the hinge pin 52 when opened. Accordingly, the first pin 521 and the second pin 522 can be spaced apart from each other so as to have an inclination corresponding to the angle of the movement direction of the upper door 21 when the door 20 starts to open.

Meanwhile, the hinge device 50 may be covered by a hinge cover 11 disposed at the upper part. The hinge cover 11 may be provided to prevent exposure of the hinge device 50. For example, the hinge fixing part 511 may be covered by the cover body part 111, and the hinge extension part 512 may be covered by the cover protrusion part 112. For example, the hinge fixing part 511 may be located at the lower part of the cover body part 111, and the hinge extension part 512 may be located at the lower part of the cover protrusion part 112.

The cover protrusion part 112 may have a shape corresponding to the hinge device 50. For example, the cover protrusion part 112 may have a shape corresponding to the hinge extension part 512. The cover protrusion part 112 may have a shape that extends forward from the cover body part 111 and is bent outwardly where the hinge pin 52 is arranged.

The cover protrusion part 112 may include a cover upper part 112a forming an upper surface, a cover front part 112b forming a front surface, a first cover side part 112c forming one side, and a second cover side part 112d forming the other side. The cover front part 112b, the first cover side part 112c, and the second cover side part 112d may form a side surface of the cover protrusion part 112.

The cover upper surface 112a can constitute the upper surface of the cover protrusion part 112. The cover upper surface 112a can be connected to the upper surface of the cover body 111. For example, the cover upper surface 112a can be aligned with the upper surface of the cover body 111.

The cover upper surface 112a may have a plane shape corresponding to the hinge extension part 512. The cover upper surface 112a may shield the hinge extension part 512 from above. The cover upper surface 112a may shield the guide hole 312h formed in the hinge mounting part 312 from above.

The cover front part 112b may constitute the front of the cover protrusion part 112. The cover front part 112b may extend downward from the front end of the cover upper part 112a. For example, the cover front part 112b may be arranged to face the cap decoration cover 33. In addition, the cover front part 112b may be arranged to face the front panel 211 that constitutes the front surface of the upper door 21. The front end of the cover front part 112b may be arranged between the guide hole 312h and the front panel 211.

The first cover side part 112c may constitute one side of the cover protrusion part 112. The first cover side part 112c may constitute one side of the cover protrusion part 112 facing the decoration body 311. The first cover side part 112c may extend downward from one end of the cover upper part 112a. For example, the first cover side part 112c may be arranged facing the decoration body 311.

The second cover side part 112d can constitute the other side that is arranged toward the outside from the cover protrusion part 112. The second cover side part 112d can be arranged opposite the first cover side part 112c. The second cover side part 112d can constitute the opposite side of the first cover side part 112d. The second cover side part 112d can extend downward from the other end of the cover upper part 112a. The second cover side part 112d can be exposed to the outside, but is not limited thereto, and can be covered by the upper door 21 and not exposed. The second cover side part 112d can be connected to the first cover side part 112c by the cover front part 112b.

The upper door 21 may be equipped with a hinge guide member 34 forming a guide groove 340. For example, the hinge guide member 34 may be provided in the hinge mounting part 312. The hinge guide member 34 may include a guide groove 340 that guides the movement of the hinge pin 52.

The hinge guide member 34 may be formed of an engineering plastic material having wear resistance and lubricity. For example, the hinge guide member 34 may be formed of a POM (Polyoxymethylene) material. Accordingly, the hinge guide member 34 may be minimized from damage even when the hinge pin 52 is repeatedly moved, thereby ensuring smooth movement of the hinge pin 52. The guide member 34 may have a shape in which both end parts are bent toward the front. For example, the guide member 34 may have a shape in which the central part is recessed rearward and both end parts are protruded forward. The guide hole 312h may be arranged so as to be surrounded by the guide member 34. The guide hole 312h may be arranged between the both end parts of the guide member 34.

A guide groove 340 that is opened upward may be formed in the hinge guide member 34. The guide groove 340 may be called a guide slot. The guide groove 340 may have a recessed groove shape as well as an open hole shape. The guide groove 340 may be configured as a single groove in which a plurality of paths having different extension directions are continuously connected.

The guide groove 340 may be formed in a bent shape corresponding to the shape of the guide member 34. For example, the shape of the guide groove 340 may have a shape in which the central part is recessed rearward and both end parts protrude forward when viewed from the front. At this time, the protrusion distances of each of the both end parts protruding forward relative to the central part may be different from each other.

A guide hole 312h may be arranged between the both end parts of the guide groove 340. The guide hole 312h may be arranged in front of the guide groove 340. The guide hole 312h may be arranged so as to be surrounded by the guide groove 340. Accordingly, the guide hole 312h may be arranged adjacent to the rotational axis of the upper door 21. Through the above structure, even if the upper door 21 is opened, the change in the position of the guide hole 312h may be minimized. Accordingly, the movement of the water supply pipe 41 communicating with the guide hole 312h may be minimized, thereby minimizing damage to the water supply pipe 41.

The hinge guide member 34 may include a pair of side parts 341 spaced apart from each other to form a guide groove 340, and a first connecting part 342 and a second connecting part 343 connecting both ends of the side parts 341. The hinge guide member 34 may further include a bottom part 345 connecting the side parts 341, the first connecting part 342, and the second connecting part 343 to form a lower surface.

A pair of side parts 341 have a shape corresponding to the extension shape of the guide groove 340 and can be spaced apart by a distance corresponding to the diameter of the hinge pin 52. A pair of side parts 341 can be spaced apart in a direction intersecting the extension direction of the guide groove 340.

The first connecting part 342 and the second connecting part 343 may be formed to be rounded with a curvature corresponding to the hinge pin 52. For example, the first connecting part 342 may be formed to be rounded with a curvature corresponding to the side surface of the first pin 521, and the second connecting part 343 may be formed to be rounded with a curvature corresponding to the side surface of the second pin 522.

A protrusion part 346 configured to come into contact with the first pin 521 when the door 20 rotates may be formed on the inner surface of the guide home 340. The protrusion part 346 may be formed on the inner surface of the side part 341.

Meanwhile, the hinge guide member 34 may further include a reinforcing part 344 for reinforcing the hinge guide member 34. The reinforcing part 344 forms the upper end of the hinge guide member 34 and may be exposed to the outside when the hinge guide member 34 is mounted on the door 20.

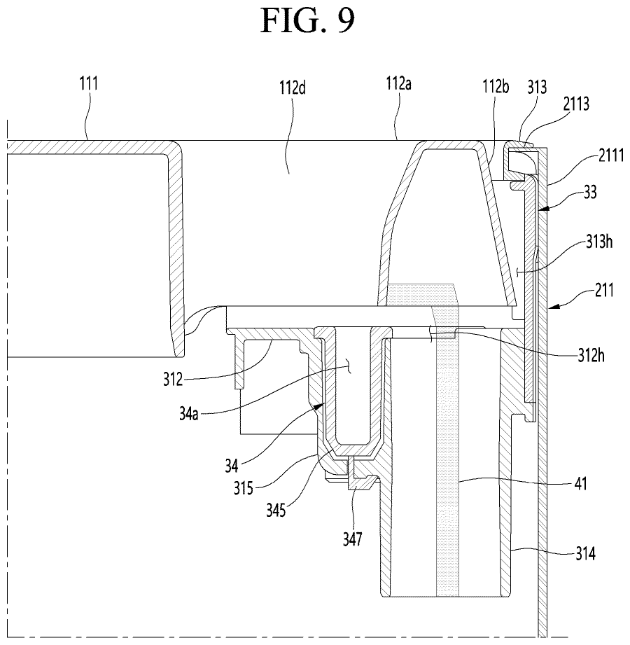

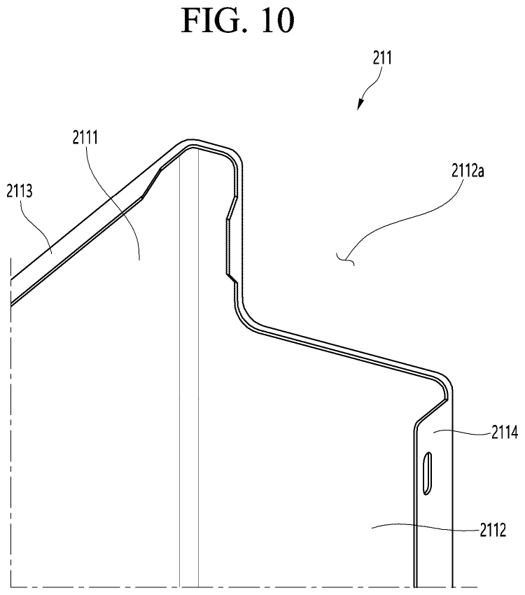

Hereinafter, the positional relationship between the hinge cover and the upper cap decoration will be described with reference to FIGS. 9 and 10.

FIG. 9 is a schematic diagram illustrating the positional relationship between the hinge cover and the upper cap decoration. FIG. 10 is a perspective view illustrating the front panel forming the front surface of the door. Referring to FIGS. 9 and 10, the cover protrusion part 112 of the hinge cover 11 can cover the hinge pin 52 to prevent exposure. Accordingly, the cover protrusion part 112 can cover a part of the guide groove 340 where the hinge pin 52 is placed by covering the hinge pin 52. Meanwhile, as the upper door 21 rotates, the hinge pin 52 can change the position thereof along the guide groove 340. Accordingly, the position of the area covered by the cover protrusion part 112 in the guide groove 340 can be changed.

In addition, the cover protrusion part 112 can cover the guide hole 312h with which the water supply pipe 41 communicates. The cover protrusion part 112 can minimize the exposure of the water supply pipe 41. For example, the cover protrusion part 112 can cover the entire guide hole 312h.

As the upper door 21 rotates, the position of the guide hole 312h may change to some extent. However, as described above, the guide hole 312h is surrounded by the guide groove 340 and arranged so that the change in position due to the rotation of the upper door 21 can be minimized. Even during the rotation of the upper door 21, the cover protrusion part 112 can cover the entire guide hole 312h. Therefore, the cover protrusion part 112 can stably cover the guide hole 312h during the rotation of the upper door 21 and prevent the exposure of the water supply pipe 41.

To this end, the front end of the cover front part 112b of the cover protrusion part 112 may be positioned further forward than the guide hole 312h. The rear end of the cover front part 112b may be positioned above the guide hole 312h. For example, the front end of the cover front part 112b may be positioned below the upper end of the cap decoration frame 313. The front end of the cover front part 112b may be positioned to overlap the cap decoration frame 313 in the vertical direction. The front end of the cover front part 112b may be positioned inside the frame opening 313h. In other words, the cover protrusion part 112 may be positioned as close as possible to the cap decoration cover 33. Through the structure, in a structure in which the hinge cover 11 covers the guide hole 312h, the thickness of the upper door 21 may be minimized.

Meanwhile, the upper cap decoration 31 can be manufactured through an injection process using a mold. Due to the characteristics of the mold injection process, in the case of a structure in which the upper cap decoration 31 and the cap decoration cover 33 are integrated, there may be a structural limitation in the mold manufacturing. Therefore, in order to have a structure that can stably cover the guide hole 312h through the cover protrusion part 112, the cap decoration cover 33 can be combined with the upper cap decoration 31 to shield the front. In other words, through the structure, it is possible to secure a space for a frame opening 31h where the front end of the cover front part 112b is arranged so that the guide hole 312h can be stably covered during the rotation process of the upper door 21.

The distance from the cap decoration cover 33 to the hinge cover 11 may be smaller than the distance from the cap decoration cover 33 to the guide hole 312h. In other words, the hinge cover 11 may be arranged closer to the cap decoration cover 33 than the guide hole 312h. For example, when the upper door 21 is closed, the cover front part 112b may be arranged closer to the cap decoration cover 33 than the guide hole 312h. As will be described later, when the upper door 21 is open, the second cover side part 112d may be arranged closer to the cap decoration cover 33 than the guide hole 312h. Through the structure, even during the rotation of the upper door 21, the cover protrusion part 112 can stably cover the guide hole 312h, thereby preventing the water supply pipe 41 from being exposed to the outside.

A front panel 211 according to one embodiment may include a panel front part 2111 forming the front surface of the upper door 21, and a panel side part 2112 bent rearward from one end of the panel front part 2111.

The panel front part 2111 can form the front surface of the upper door 21. The panel front part 2111 can be arranged to face the hinge cover 11 in the front and rear direction. The panel front part 2111 can be arranged to face the upper cap decoration 31 in the front and rear direction. The panel front part 2111 can be arranged to face the cap decoration cover 33 in the front and rear direction.

A front bent part 2113 that is bent backwards may be formed at the upper end of the panel front part 2111. The front bent part 2113 may be formed for mounting on the upper end of the front panel 211. For example, the front bent part 2113 may be mounted on the cap decoration frame 313. The front bent part 2113 may be partially inserted into the cap decoration frame 313.

The front bent part 2113 may be arranged to overlap the cover front part 112b in the vertical direction. The end part of the front bent part 2113 may be arranged rearward relative to the front end of the cover front part 112b. The front bent part 2113 may be positioned above the frame opening 313h. The end part of the front bent part 2113 may be positioned rearward relative to the rear surface of the cap decoration cover 33. The end part of the front bent part 2113 may be positioned rearward relative to the front end of the upper cap decoration 31.

The panel side part 2112 can form the side of the upper door 21. A panel cut-out part 2112a can be formed at the upper end of the panel side part 2112. The panel cut-out part 2112a can expose the hinge mounting part 31a of the upper cap decoration 31.

A side bent part 2114 that is bent inwardly may be formed at the rear end of the panel side part 2112. The side bent part 2114 may be formed for mounting on the side end of the front panel 211. For example, the side bent part 2114 may be mounted on a door frame 210.

Meanwhile, the hinge guide member 34 is arranged at the lower part of the bottom part 345 and may further include a guide fastening part 347 having a hook shape. The upper cap decoration 31 may further include a guide member mounting part 315 formed by being recessed in the hinge mounting part 312. The guide member mounting part 315 may be formed by being recessed in a shape corresponding to the hinge guide member 34. The guide member mounting part 315 may be arranged at the rear of the guide connecting part 314. For example, the guide fastening part 347 of the hinge guide member 34 may be fastened to and fixed to the guide member mounting part 315.

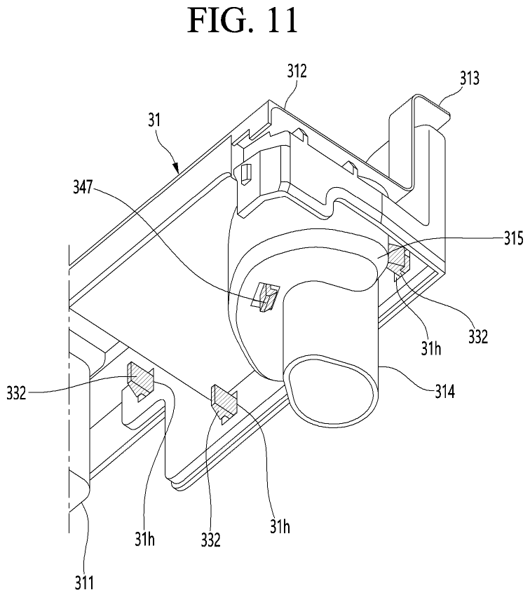

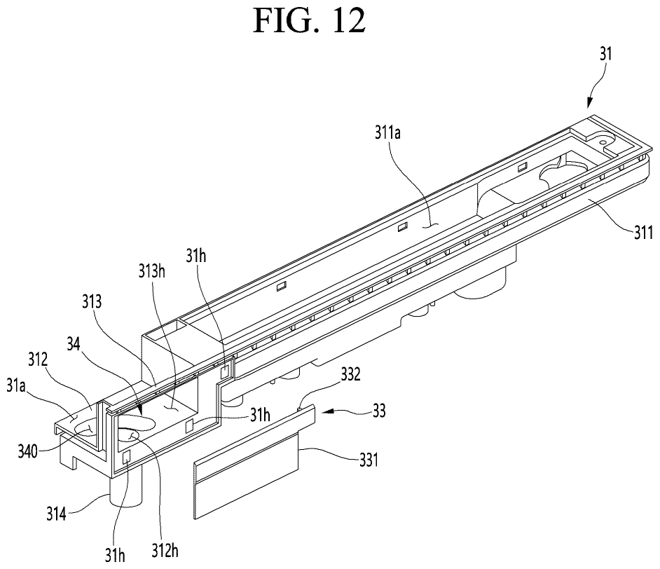

FIG. 11 is a bottom perspective view illustrating a hinge mounting part of an upper cap decoration according to one embodiment. FIG. 12 is an exploded perspective view illustrating the upper cap decoration and cap decoration cover according to one embodiment.

Referring to FIGS. 11 and 12, the cap decoration cover 33 may include a cover part 331 that shields the frame opening 313h and a cover mounting part 332 formed on one surface of the cover part 331. As an example, the cover mounting part 332 may be formed in a hook shape. A plurality of cover mounting parts 332 may be provided.

The upper cap decoration 31 may include a cover mounting hole 31h arranged on the front surface. A hook-shaped cover mounting part 332 may be mounted and fixed in the cover mounting hole 31h. The cover mounting hole 31h may be formed at a position corresponding to the cover mounting part 332. For example, the number of cover mounting holes 31h may be formed as many as the number of cover mounting parts 332.

Through the structure, the cap decoration cover 33 can be firmly fixedly mounted to the cap decoration frame 313 of the upper cap decoration 31.

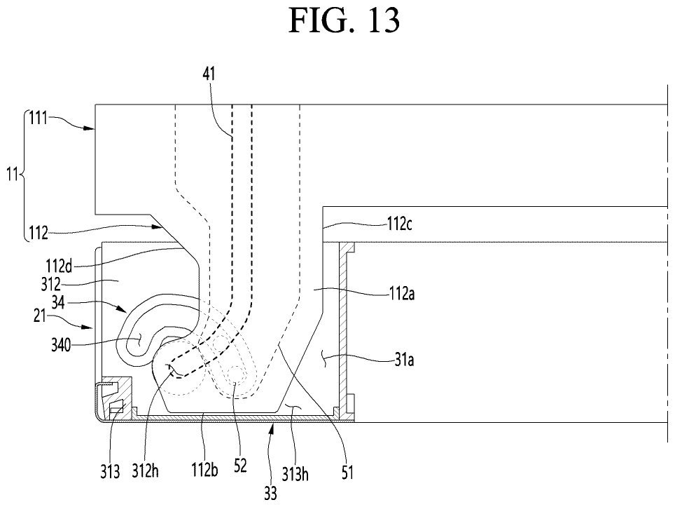

Hereinafter, the positional relationship between each component according to the opening process of the upper door 21 will be described with reference to FIGS. 13 to 16.

FIGS. 13 to 16 are schematic diagrams illustrating the door opening process.

Referring to FIG. 13, when the upper door 21 is closed, the cover protrusion part 112 can cover the hinge pin 52. As the cover protrusion part 112 covers the hinge pin 52, it can cover the part of the guide member 34 where the hinge pin 52 is arranged. The cover protrusion part 112 can be arranged facing the cap decoration cover 33. The cover protrusion part 112 can be arranged closer to the cap decoration cover 33 than the guide hole 312h. The cover protrusion part 112 can cover the guide hole 312h. Therefore, the cover protrusion part 112 can cover the water supply pipe 41 that communicates with the inside of the upper door 21 through the guide hole 312h to prevent exposure.

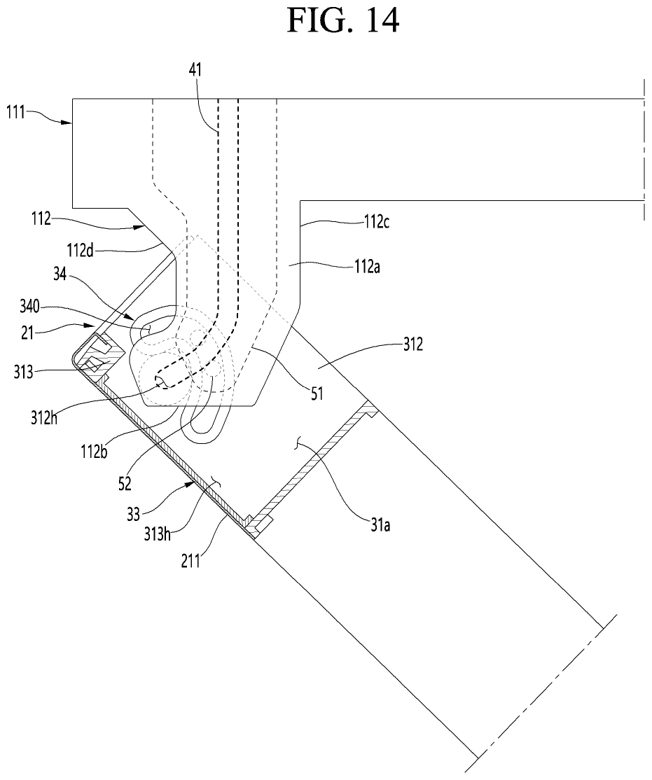

Referring to FIG. 14, the upper door 21 may start to open when the hinge pin 52 starts to move along the guide groove 340 of the guide member 34. Since the cover protrusion part 112 and the hinge device 50 are mounted on the cabinet 10, their positions may not change even when the upper door 21 is opened. The cover protrusion part 112 may cover the hinge pin 52. Since the cover protrusion part 112 covers the hinge pin 52, it may cover a part of the guide member 34 where the hinge pin 52 is arranged. The cover protrusion part 112 may be arranged closer to the cap decoration cover 33 than to the guide hole 312h. The cover front part 112b of the cover protrusion part 112 may be arranged between the guide hole 312h and the cap decoration cover 33.

The front end of the cover front part 112b can be placed between the guide hole 312h and the front panel 211. The cover protrusion part 112 can cover the guide hole 312h to prevent exposure of the water supply pipe 41 that communicates with the interior of the upper door 21 through the guide hole 312h.

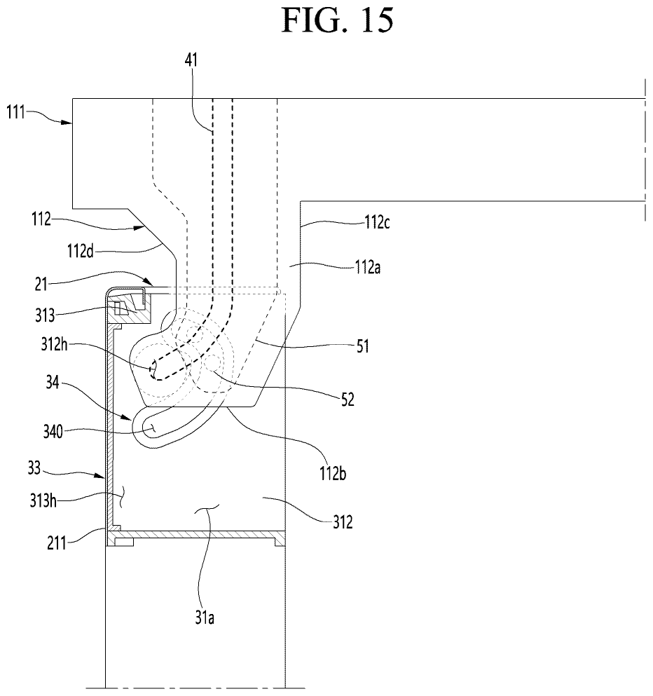

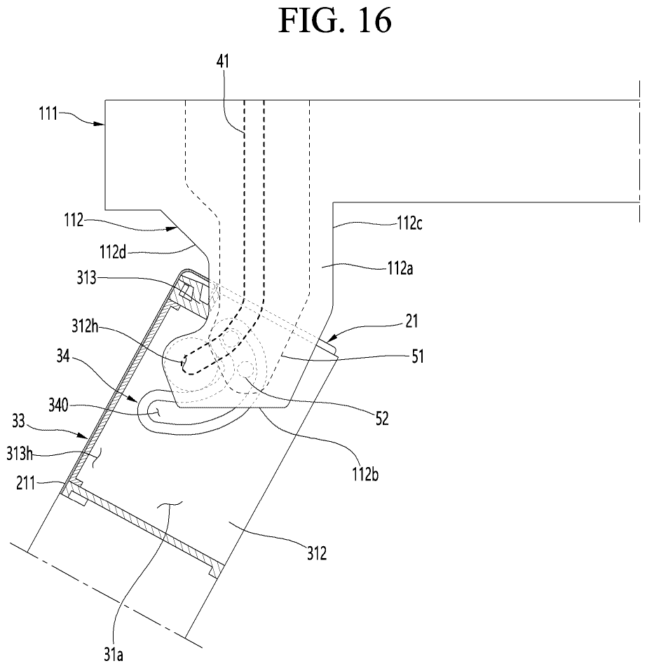

Referring to FIGS. 15 and 16, the upper door 21 can be opened by 90° or more as the hinge pin 52 moves along the guide groove 340 of the guide member 34. The cover protrusion part 112 can cover the hinge pin 52. As the cover protrusion part 112 covers the hinge pin 52, it can cover a part of the guide member 34 where the hinge pin 52 is disposed. The cover protrusion part 112 can be disposed closer to the cap decoration cover 33 than the guide hole 312h. The second cover side part 112d of the cover protrusion part 112 can be disposed between the guide hole 312h and the cap decoration cover 33. The front end of the cover front part 112b can be disposed between the guide hole 312h and the front panel 211. The cover protrusion part 112 covers the guide hole 312h, thereby preventing exposure of the water supply pipe 41 communicating with the interior of the upper door 21 through the guide hole 312h.

In other words, the hinge cover 11 included in the refrigerator 1 according to one embodiment may include a cover protrusion part 112 extended toward the front side of the upper cap decoration 31. In the process of opening the door 20, the hinge cover 11 may maintain a state of covering the guide hole 312h. In addition, in the process of opening the door 20, the front end of the cover front part 112b may maintain a state of being arranged between the guide hole 312h and the front panel 211. In the process of opening the door 20, the front end of the cover front part 112b may maintain a state of being arranged between the guide hole 312h and the cap decoration cover 33. Therefore, in the process of opening the door 20, the guide hole 312h with which the water supply pipe 41 communicates may be stably covered, thereby preventing the exposure of the water supply pipe 41.

According to a refrigerator 1 according to one embodiment, when the door 20 rotates, interference with the wall 0 on which the refrigerator 1 is installed can be prevented, thereby minimizing the distance from the wall 0.

According to a refrigerator 1 according to one embodiment, two hinge pins 52 are configured to move along guide grooves 340 formed on the upper surface of the door 20, so that the operational feel when the door 20 is opened and closed can be improved.

According to a refrigerator 1 according to one embodiment, the hinge device 50 is covered from the upper part, thereby preventing the water supply pipe 41 from being exposed to the outside even during the rotation of the door 20, by means of the hinge cover 11 that covers the guide hole 312h through which the water supply pipe 41 that supplies water to the door 20 passes, According to a refrigerator 1 according to one embodiment, the thickness of the door 20 can be configured slimly by means of a structure that minimizes the distance between the hinge cover 11 covering the hinge device 50 and the guide hole 312h and the front surface of the door 20.

According to a refrigerator 1 according to one embodiment, by means of a structure including an upper cap decoration 31 and a cap decoration cover 33 coupled to the front of the upper cap decoration 31, a structure in which a hinge cover 11 covers a guide hole 312h through which a water supply pipe 41 passes can be easily manufactured in a door 20 having a guide hole 312h formed on the upper surface.

Meanwhile, the present disclosure may have various other embodiments in addition to the above-described embodiments. Hereinafter, other embodiments of the present disclosure will be described with reference to the drawings. Among the configurations of other embodiments of the present disclosure, the same configurations as the above-described embodiments may be omitted for detailed description and illustration, and may be described using the same drawing reference numerals. In other words, only the structures that are different from the above-described embodiments will be described below, and other configurations that are not described may be the same as the above-described embodiments.

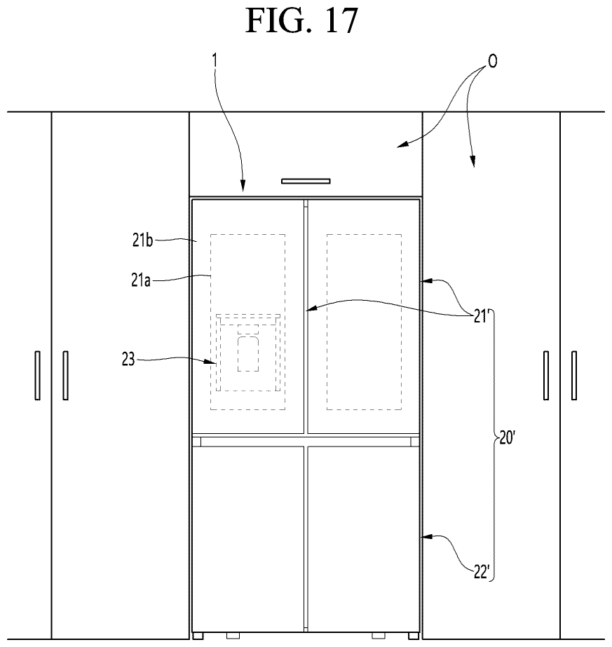

FIG. 17 is a perspective view illustrating an upper cap decoration according to another embodiment.

Referring to FIG. 17, the cap decoration cover 33 of the present embodiment can be mounted on the front surface of the upper cap decoration 31 via a fastening member 33a. The fastening member 33a can be configured as a screw. The cap decoration cover 33 of the present embodiment can omit the cover mounting part 332.

Through the above structure, the cap decoration cover 33 can be firmly fixedly mounted to the cap decoration frame 313 of the upper cap decoration 31.

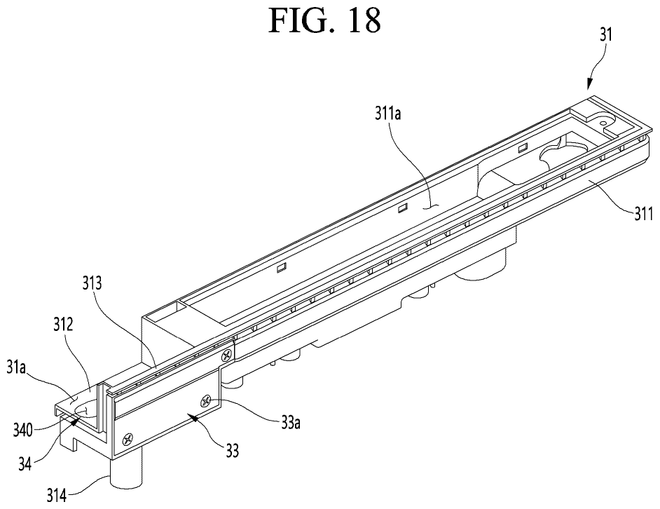

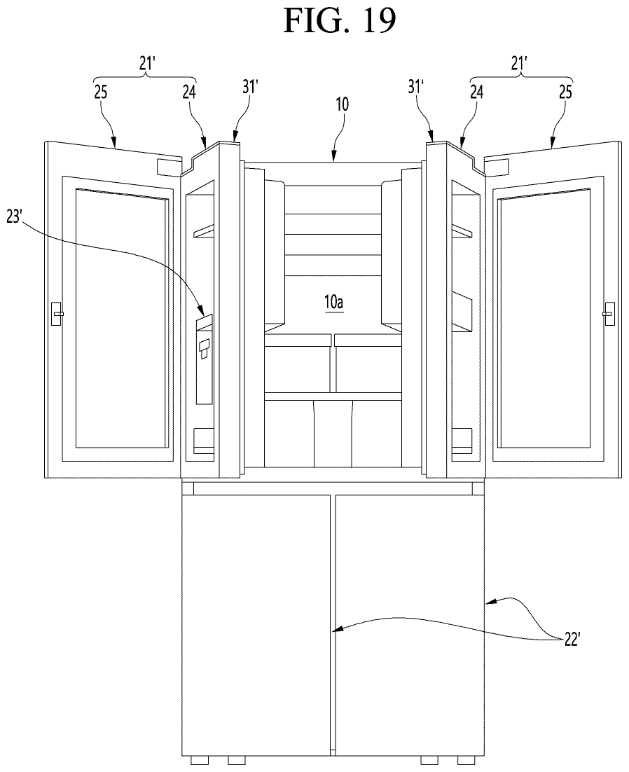

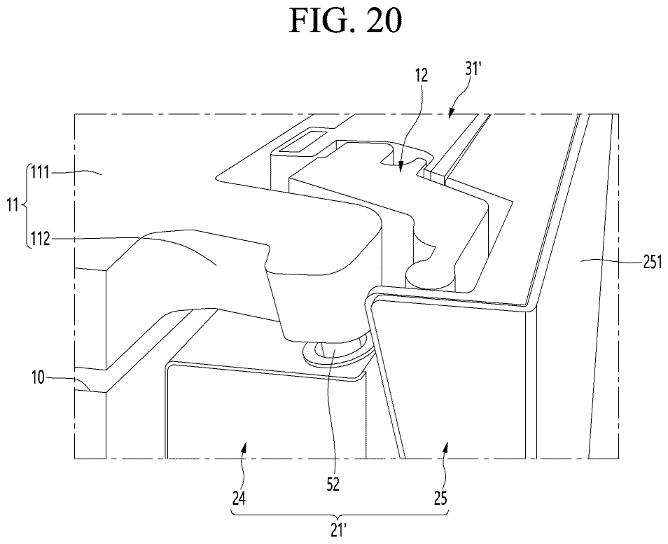

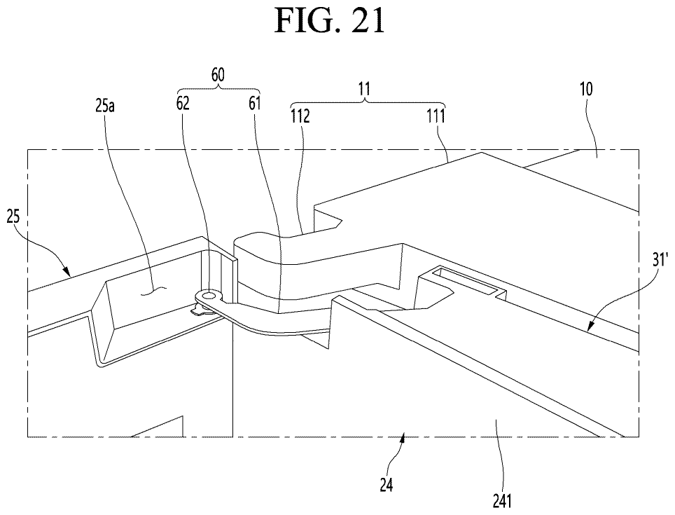

FIG. 18 is a front view illustrating a refrigerator according to another embodiment. FIG. 19 is a front view illustrating a state where a door of a refrigerator is open according to another embodiment. FIG. 20 is an enlarged perspective view illustrating a door hinge part of a refrigerator according to another embodiment. FIG. 21 is an enlarged perspective view illustrating a door hinge part in a state where the sub-door is open in a refrigerator according to another embodiment. FIG.

22 is an exploded perspective view illustrating the upper cap decoration and the sub door in a refrigerator according to another embodiment.

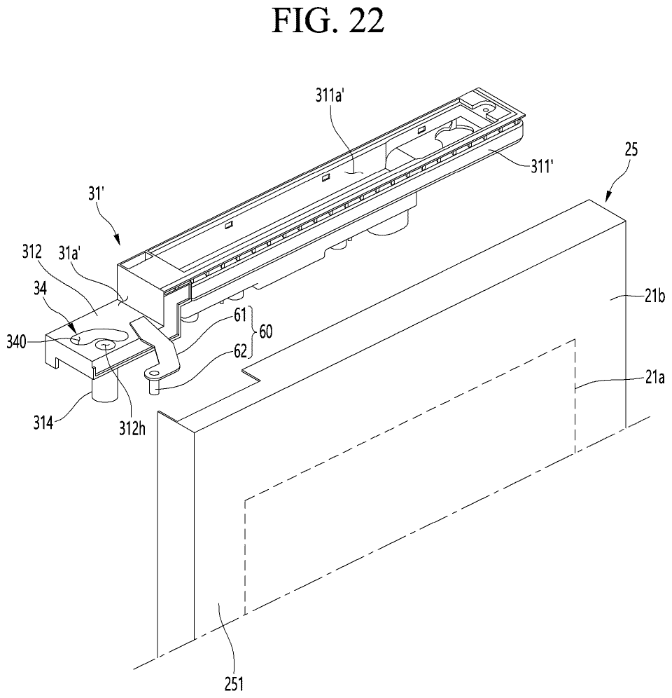

Referring to FIGS. 18 to 22, the refrigerator 1′ according to the present embodiment may include a door 20′ having a different structure from the refrigerator 1 according to one embodiment. For example, the door 20′ according to the present embodiment may include an upper door 21′ for opening and closing an upper storage space 10a of the cabinet 10 and a lower door 22′ for opening and closing a lower storage space of the cabinet 10. The upper door 21′ and the lower door 22′ may be rotatably connected to the cabinet 10.

In this embodiment, the upper door 21′ may include a main door 24 rotatably connected to the cabinet 10 and a sub door 25 rotatably connected to the main door 24. The main door 24′ is rotatably connected to the cabinet 10 and can open and close the upper storage space 10a. The sub door 25′ is rotatably connected to the main door 24′ and can open and close the internal storage space of the main door 24′.

Meanwhile, in the present embodiment, the front surface of the upper door 21′ may include a see-through part 21a configured to allow seeing through the inside of the main door 24 and a bezel part 21b arranged around the see-through part 21a. The bezel part 21b may be arranged to surround the see-through part 21a.

A dispenser 23 may be provided inside the main door 24. The dispenser 23 of the present embodiment may be substantially the same as the dispenser 23 of the refrigerator 1 according to one embodiment. The dispenser 23 provided inside the main door 24 may be viewed from the front of the refrigerator 1′ through the see-through part 21a.

The main door 24 may include an upper cap decoration 31′ forming an upper surface. The upper cap decoration 31′ of the present embodiment may have a structure similar to the upper cap decoration 31 included in the refrigerator 1 according to one embodiment. Hereinafter, the difference between the upper cap decoration 31′ included in the refrigerator 1′ of the present embodiment and the upper cap decoration 31 included in the refrigerator 1 according to one embodiment will be described.

In the present embodiment, the upper cap decoration 31′ may not include the cap decoration frame 313. In other words, the upper cap decoration 31′ of the present embodiment may include a decoration body 311′ and a hinge mounting part 312′ formed by being recessed downward on one side of the decoration body 311′. A hinge mounting space 31a′ may be formed on the hinge mounting part 312′. A guide member 34 including a guide groove 340 may be arranged on the hinge mounting part 312′, and a guide hole 312h may be formed.

In this embodiment as well, the cover protrusion part 112 of the hinge cover 11 can cover the guide hole 312h. As described above with reference to FIGS. 13 to 16, the guide hole 312h can be covered by the cover protrusion part 112 even during the rotation of the main door 24. Therefore, even if the main door 24′ rotates, the hinge cover 11 can prevent the external exposure of the water supply pipe 41.

A sub hinge device 60 provided for rotation of the sub door 25 may be placed in the hinge mounting part 312′. The sub door 25 may rotate with respect to the main door 24 through the sub hinge device 60.

Meanwhile, the sub door 25 may include a sub hinge mounting part 25a formed by having an upper surface recessed downward. A sub hinge device 60 may be rotatably coupled to the sub hinge mounting part 25a.

The sub hinge device 60 can connect the upper part of the main door 24 and the sub door 25. The sub hinge device 60 can include a sub hinge plate 61 and a sub hinge pin 62.

The sub-hinge plate 61 may be formed of a plate-shaped metal material and may protrude forward from the hinge mounting part 312′. The sub-hinge plate 61 may extend to the sub-hinge mounting part 25a of the sub-door 25. For example, the sub-hinge plate 61 may be fixed to the main door 24 and may have a shape that extends toward the sub-door 25.

A sub-hinge pin 62 may be mounted on the front end part of the sub-hinge plate 61 positioned on the sub-hinge mounting part 25a. For example, the sub-hinge pin 62 may extend downward from the front end of the sub-hinge plate 61. The sub-hinge pin 62 may be press-fitted and coupled so as to penetrate the sub-hinge plate 61.

The sub-hinge device 60 may be covered by the sub-hinge cover 12. The sub-hinge device 60 may not be exposed to the outside by the sub-hinge cover 12. The sub-hinge cover 12 may be arranged across the main door 24 and the sub-door 25. For example, the sub-hinge cover 12 may extend from the hinge mounting part 312′ of the upper cap decoration 31′ to the sub-hinge mounting part 25a of the sub-door 25. In other words, the sub-hinge cover 12 may be configured to correspond to the shape of the sub-hinge device 60.

Meanwhile, in the refrigerator 1′ of the present embodiment, the connection structure between the cabinet 10 and the main door 24 may be substantially the same as the connection structure between the cabinet 10 and the upper door 21 in the refrigerator 1 of one embodiment. In other words, in the refrigerator 1′ of the present embodiment, the cabinet 10 and the main door 24 may be connected by a hinge device 50 as described above with reference to FIGS. 6 to 8.

What is claimed is:

1. A refrigerator comprising:
a cabinet having a storage space;
a door configured to open and close the storage space and including a hinge mounting part formed on an upper surface of the door;
a hinge device including a hinge plate mounted on the cabinet, and a hinge pin protruding from the hinge plate toward the door and connected to the hinge mounting part;
a hinge cover arranged across an upper surface of the cabinet and the hinge mounting part and covering the hinge device; and
a guide member provided on the hinge mounting part and having a guide groove configured to allow the hinge pin to be inserted and guiding movement of the hinge pin when the door rotates,
wherein the hinge mounting part has a guide hole that is arranged in front of the guide member and in which a water supply pipe extending from the cabinet to an inside of the door is guided.

2. The refrigerator of claim 1,
wherein the hinge cover maintains a state of covering the guide hole during a rotation process of the door.

3. The refrigerator of claim 1,
wherein the hinge pin includes a first pin and a second pin that are spaced apart from each other, and
wherein the guide groove is configured so that both the first pin and the second pin are inserted, the guide groove being configured to guide movement of the first pin and the second pin when the door rotates.

4. The refrigerator of claim 1,
wherein the door further includes an upper cap decoration that forms the upper surface of the door and includes the hinge mounting part, and
wherein a front end of the hinge cover is disposed between the guide hole and a front surface of the upper cap decoration.

5. The refrigerator of claim 4,
wherein the front end of the hinge cover is maintained in a state of being disposed between the guide hole and the front surface of the upper cap decoration during a rotation process of the door.

6. The refrigerator of claim 4,
wherein the door further includes a front panel forming a front surface of the door, and
wherein the front panel covers the front surface of the upper cap decoration.

7. The refrigerator of claim 1,
wherein the door includes:
an upper cap decoration forming an upper surface of the door and including the hinge mounting part, and
a cap decoration cover mounted on a front surface of the upper cap decoration,
wherein the upper cap decoration includes:
a cap decoration frame having a frame opening and arranged in front of the hinge mounting part, and
wherein the cap decoration cover covers the frame opening.

8. The refrigerator of claim 7,
wherein a front end of the hinge cover is located inside the frame opening.

9. The refrigerator of claim 7,
wherein a front end of the hinge cover is disposed between the guide hole and the cap decoration cover.

10. The refrigerator of claim 7,
wherein the upper cap decoration includes a cover mounting hole disposed on the front surface thereof, and
wherein the cap decoration cover includes a cover mounting part mounted on the cover mounting hole.

11. The refrigerator of claim 7,
wherein the door further includes a front panel forming a front surface of the door, and
wherein the front panel covers a front surface of the cap decoration cover.

12. The refrigerator of claim 1,
wherein the hinge cover includes a cover body part disposed on an upper surface of the cabinet, and
a cover protrusion part extended forward from the cover body part and disposed on the hinge mounting part, and
wherein the cover protrusion part maintains a state of covering the guide hole during a rotation process of the door.

13. The refrigerator of claim 12,
wherein the door further includes a front panel forming a front surface of the door, and
wherein a front end of the cover protrusion part is maintained in a state of being arranged between the guide hole and the front panel during a rotation of the door.

14. The refrigerator of claim 1,
wherein the guide member has a shape in which both end parts are bent toward a front, and
wherein the guide member is arranged to surround the guide hole.

15. The refrigerator of claim 1, further comprising:
a dispenser provided inside the door, configured to dispense water, and connected to the water supply pipe,
wherein the water supply pipe is guided through the hinge cover and the guide hole and extends to the dispenser.
